(19) United States
(12) Patent Application Publication
(10) Pub. No.: US 2016/0269342 A1
(43) Pub. Date: Sep. 15, 2016

(54) MEDIATING MESSAGES WITH NEGATIVE SENTIMENTS IN A SOCIAL NETWORK

(71) Applicant: International Business Machines Corporation, Armonk, NY (US)

(72) Inventors: Judith H. Bank, Cary, NC (US); Lisa M.W. Bradley, Cary, NC (US); Aaron J. Quirk, Cary, NC (US); Lin Sun, Morrisville, NC (US)

(73) Assignee: International Business Machines Corporation, Armonk, NY (US)

(21) Appl. No.: 14/641,712

(22) Filed: Mar. 9, 2015

(51) Int. Cl. H04L 12/58

(52) U.S. Cl. CPC H04L 51/32; H04L 51/12

(57) ABSTRACT

Mediating messages with negative sentiments in a social network includes monitoring a number of messages in a social network, analyzing content of the number of messages to identify negative sentiments about a victim in the social network, determining a threshold, the threshold defining a maximum number of the messages containing the negative sentiments that are allowed to be disseminated about the victim, and executing, based on the threshold, an action to mediate the negative sentiments about the victim.

### BACKGROUND

The present invention relates to mediating messages with negative sentiments, and more specifically, to mediating messages with negative sentiments in a social network.

A social network is a network based application to enable a user to create a user account. Once the user account is created, the user establishes connections with other users, such as friends, family, and colleagues in an online environment. Further, once the user is connected with other users, the user may share information, in the form of messages, with each of the other users on the social network by uploading pictures, updating personal information, updating status information, commenting on other user's information, among other activities.

### BRIEF SUMMARY

A method for mediating messages with negative sentiments in a social network includes monitoring a number of messages in a social network, analyzing content of the number of messages to identify negative sentiments about a victim in the social network, determining a threshold, the threshold defining a maximum number of the messages containing the negative sentiments that are allowed to be disseminated about the victim, and executing, based on the threshold, an action to mediate the negative sentiments about the victim.

A system for mediating messages with negative sentiments in a social network includes a receiving engine to receive a number of user preferences for a victim, a monitoring engine to monitor a number of messages in a social network, an analyzing engine to analyze content of the number of messages to identify negative sentiments about the victim in the social network, a determining engine to determine a threshold, the threshold defining a maximum number of the messages containing the negative sentiments that are allowed to be disseminated about the victim, and an executing engine to execute, based on the threshold, an action to mediate the negative sentiments about the victim.

A computer program product includes a computer readable storage medium, the computer readable storage medium having computer readable program code embodied therewith. The computer readable program code having computer readable program code to analyze content of a number of messages to identify negative sentiments about a victim in a social network, determine a threshold, the threshold defining a maximum number of the messages containing the negative sentiments that are allowed to be disseminated about the victim, execute, based on the threshold, an action to mediate the negative sentiments about the victim.

### BRIEF DESCRIPTION OF THE SEVERAL VIEWS OF THE DRAWINGS

The accompanying drawings illustrate various examples of the principles described herein and are a part of the specification. The examples do not limit the scope of the claims.

FIG. 1 is a diagram of a system for mediating messages with negative sentiments in a social network, according to one example of principles described herein.

FIG. 2 is a diagram of a system for mediating messages with negative sentiments in a social network, according to one example of principles described herein.

FIG. 3 is a flowchart of a method for mediating messages with negative sentiments in a social network, according to one example of principles described herein.

FIG. 4 is a flowchart of a method for mediating messages with negative sentiments in a social network, according to one example of principles described herein.

FIG. 5 is a diagram of a mediating system, according to the principles described herein.

FIG. 6 is a diagram of a mediating system, according to the principles described herein.

Throughout the drawings, identical reference numbers designate similar, but not necessarily identical, elements.

### DETAILED DESCRIPTION

The present specification describes a method and system for mediating messages with negative sentiments in a social network, such that an equal or larger number of messages with positive sentiments are disseminated about a victim.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, a social network is a network based application to enable a user to create a user account and share information with other users. Often, information is shared in the form of a message. The message may be posted to a wall of a user. Once the message is posted to the wall of the user, other users may view the message and/or comment on the message.

While the message may be posted to the wall of the user, the message may include negative sentiments. The negative sentiments may be derogatory, untrue, and bullying in nature. Further, the negative sentiments may incite other users in rioting, looting, vandalism, or violent activities.

The principles described herein include a system and a method for mediating messages with negative sentiments in a social network. Such a system and method includes monitoring a number of messages in a social network, analyzing content of the number of messages to identify negative sentiments about a victim in the social network, determining a threshold, the threshold defining a maximum number of the messages containing the negative sentiments that are allowed to be disseminated about the victim, and executing, based on the threshold, an action to mediate the negative sentiments about the victim. Such a method and system generates or prompts other users to generate messages with positive sentiments to be about the victim. As a result, an equal or larger number of messages with positive sentiments are disseminated about the victim.

In the specification and appended claims, the term “message” means communications between a number of users on a social network. The message may include negative sentiments about the victim.

In the specification and appended claims, the term “computer generated message” means communications disseminated about a victim that includes positive sentiments. The computer generated message may be a message that is generated by a system and refutes the negative sentiments about the victim.

In the specification and appended claims, the term “user generated message” means communications disseminated about a victim that includes positive sentiments. The user generated message may be a message that is generated by a user of a social network and refutes the negative sentiments about the victim.

In the specification and appended claims, the term “negative sentiments” means adverse opinions, thoughts, views, or ideas expressed about a victim. The negative sentiments may or may not be truthful.

In the specification and appended claims, the term “victim” means an individual, a community, a business entity, or a document that negative sentiments are disseminated about. The victim may be subjected to bullying by other users of the social network.

In the specification and appended claims, the term “threshold” means a maximum number of messages containing negative sentiments that are allowed to be disseminated about a victim. The threshold may be selected by the victim via a user interface (UI). The threshold may be zero or a number greater than zero.

In the specification and appended claims, the term “action” means an act to refute a message with negative sentiments. The action may be an alert, prompting user to generate user generated message, generating computer generated message, other actions, or combinations thereof.

In the specification and appended claims, the term “user preferences” means a mechanism for a victim to define when and how to execute an action to refute a message with negative sentiments. The victim may define and/or select the user preferences via a UI.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

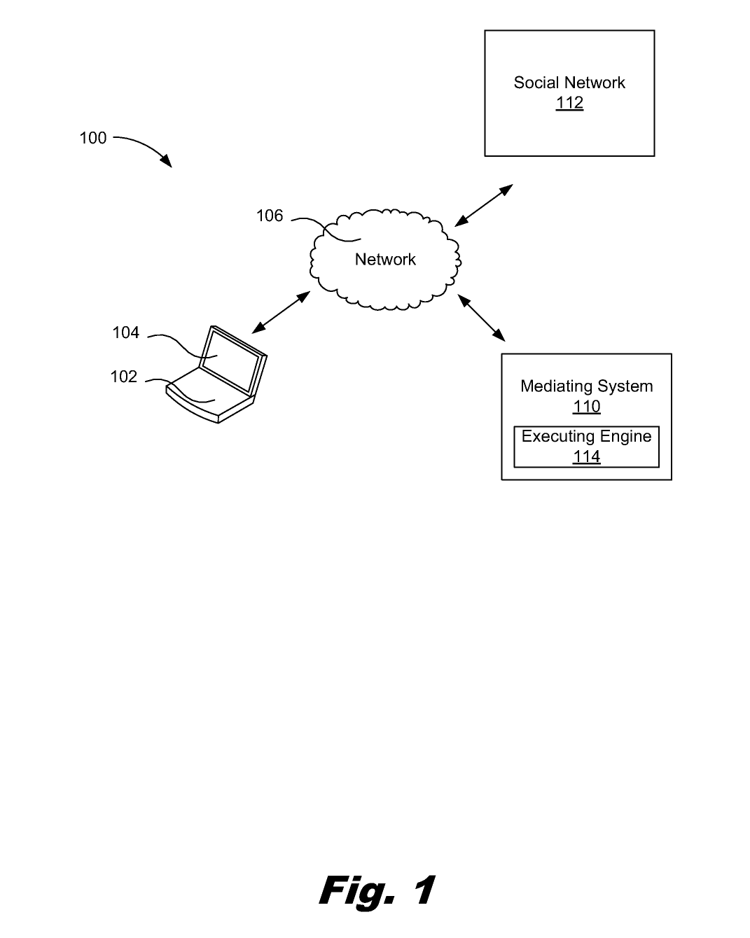

FIG. 1 is a diagram of a system for mediating messages with negative sentiments in a social network, according to one example of principles described herein. As will be described below, a mediating system is in communication with a network to monitor a number of messages in a social network. The mediating system analyzes content of the number of messages to identify negative sentiments about a victim in the social network. Further, the mediating system determines a threshold, the threshold defining a maximum number of the messages containing the negative sentiments that are allowed to be disseminated about the victim. The mediating system executes, based on the threshold, an action to mediate the negative sentiments about the victim.

As illustrated in FIG. 1, the system (100) includes social network (112). The social network (112) is a network based application to enable a user to create a user account. Once the user account is created, the user establishes connections with other users, such as friends, family, and colleagues in an online environment. Further, once the user is connected with other users, the user may share information, in the form of messages, with each of the other users on the social network (112) by uploading pictures, updating personal information, updating status information, commenting on other user's information, among other activities.

As illustrated in FIG. 1, the system (100) includes a user device (102). The user device (102) allows users of the social network (112) to access the social network (112), create user accounts, establish connections with other users, and share information. Further, the user device (102) may allow a victim to define user preferences.

As illustrated in FIG. 1, the system (100) includes a mediating system (110). The mediating system (110) may be in communication with the social network (112) and the user device (102) over a network (106).

The mediating system (110) monitors a number of messages in a social network (112). The mediating system (110) may monitor the number of messages in the social network (112) based on user preferences.

The mediating system (110) analyzes content of the number of messages to identify negative sentiments about a victim in the social network (112). The content of the number of messages may include keywords, topics, or phrases contained in the messages. The negative sentiments may include keywords, topics, or phrases that may be derogatory in nature about the victim. The keywords, topics, or phrases to be monitored may be based on user preferences.

The mediating system (110) determines a threshold. The threshold may be a maximum number of the messages containing the negative sentiments that are allowed to be disseminated about the victim. The threshold may be selected by the victim as user preferences. The threshold may be zero or a number greater than zero. If the victim selects a threshold of two, two messages with the negative sentiments are allowed to be disseminated about the victim before an action is executed.

The mediating system (110) executes, based on the threshold, an action to mediate the negative sentiments about the victim. The mediating system (110) may utilize an executing engine (114) to execute the action when the threshold is exceeded. As will be described below the action may include alerting the victim via an alert, generating computer generated messages, generating user generated messages, or combinations thereof. As a result, an equal or larger number of messages with positive sentiments are disseminated about the victim.

While this example has been described with reference to the mediating system being located over the network, the mediating system may be located in any appropriate location. For example, the mediating system may be located in a user device, a database, a social network, other locations, or combinations thereof.

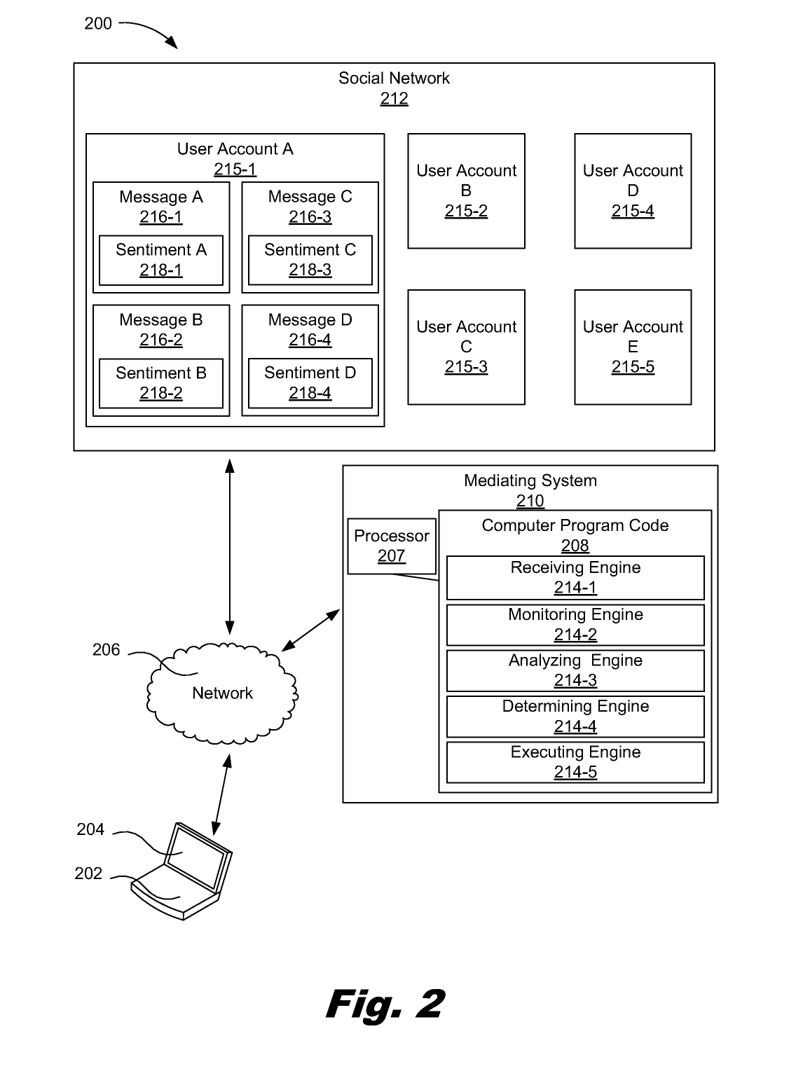

FIG. 2 is a diagram of a system for mediating messages with negative sentiments in a social network, according to one example of principles described herein. As mentioned above, a mediating system is in communication with a network to monitor a number of messages in a social network. The mediating system analyzes content of the number of messages to identify negative sentiments about a victim in the social network. Further, the mediating system determines a threshold, the threshold defining a maximum number of the messages containing the negative sentiments that are allowed to be disseminated about the victim. The mediating system executes, based on the threshold, an action to mediate the negative sentiments about the victim.

As illustrated in FIG. 2, the system (200) includes a social network (212). The social network (212) may include a number of user accounts (215). Each of the user accounts (215) may be associated with a user of the social network (212). As depicted, the social network (212) includes user account A (215-1), user account B (215-2), user account C (215-3), user account D (215-4), and user account E (215-5). In one example, user account A (215-1) has established connections with user account B (215-2), user account C (215-3), user account D (215-4), and user account E (215-5). As a result, the users of user account B (215-2), user account C (215-3), user account D (215-4), and user account E (215-5) may share information, in the form of messages, with user account A (215-1) on the social network (212) by uploading pictures, updating personal information, updating status information, commenting on other user's information, among other activities.

Further, user account A (215-1) includes a number of messages (216) that other users have shared with the user of user account A (215-1). The messages (216) include message A (216-1) and message B (216-2). Message A (216-1) may be a message sent by a user of user account B (215-2). Message B (216-2) may be a message sent by a user of user account C (215-3). Further, message A (216-1) and message B (216-2) include sentiments. As illustrated, message A (216-1) may include sentiment A (218-1) and message B (216-2) may include sentiment B (218-2). Sentiment A (218-1) and sentiment B (218-2) may be negative sentiments about the user of user account A (215-1). As a result, the user of user account A (215-1) may be a victim. As will be described below, message C (216-3) and message D (216-4) may be user generated messages or computer generated messages that refute the negative sentiments in message A (216-1) and message B (216-2). As a result, sentiment C (218-3) and sentiment D (218-4) may include positive sentiments about the victim. Further, each of the messages (216) may be posted to the user account A's wall such that other users may view the messages (216).

Although not depicted, user account B (215-2), user account C (215-3), user account D (215-4), and user account E (215-5) may include messages. Further, the messages for user account B (215-2), user account C (215-3), user account D (215-4), and user account E (215-5) may include sentiments.

As illustrated in FIG. 2, the system (200) includes a user device (202). The user device (202) allows users of the social network (212) to access the social network (212), create user accounts, establish connections with other users, and share information in the form of messages. The display (204) of the user device (202) may be used to display walls associated with each of the user accounts (215).

While this example has been described with reference to posting messages to user's walls, the messages may be posted in any appropriate location on the social network. The messages may be posted to an activity stream that includes a number of messages from a number of users.

As illustrated in FIG. 2, the system (200) includes a mediating system (210). The mediating system (210) includes a processor (207) and computer program code (208). The computer program code (208) is communicatively computed to the processor (207). The computer program code (208) includes a number of engines (214). The engines (214) refer to program instructions to perform a designated function. The program code (208) causes the processor (207) to execute the designated function of the engines (214). As illustrated, the mediating system (210) includes a receiving engine (214-1), a monitoring engine (214-2), an analyzing engine (214-3), a determining engine (214-4), and an executing engine (214-5).

The receiving engine (214-1) receives a number of user preferences for a victim. As described above, the victim is the user associated with user account A (215-1). The victim may specify the user preferences via a UI displayed on the display (204) of the user device (202). The user preferences may include a time for monitoring the number of messages (216) in the social network. The time may be specified as years, months, days, and minutes. The time may include a range of time such as allowing the monitoring engine (214-2) to monitor messages (216) for everyday between 9:00 am and 5:00 pm.

The user preferences may include topics associated with the negative sentiments. The victim may specify topics such as unacceptable behaviors, dating, user's names, other topics, or combinations thereof. If these topics are identified in messages, the messages may be identified as messages with negative sentiments.

The user preferences may include a threshold. The victim may select the threshold and the threshold may be zero. If the victim selects a threshold of zero, one message with negative sentiments disseminated about the victim exceeds the threshold. As a result, an action is executed. Further, at the sole discretion of the victim, the victim may select a threshold greater than zero. If the victim selects a threshold greater than zero, an action is not executed until the threshold is exceeded. If the victim specifies a threshold of two, then two messages with negative sentiments are allowed at the user's sole discretion before an action is executed. Further, the threshold may be associated with other user preferences. For example, a threshold of one may be selected by the victim for user account B (215-2). As a result, one message with negative sentiments is allowed from the user associated with user account B (215-2) before an action is executed. However, a threshold of three may be selected by the victim for user account C (215-3). As a result, three messages with negative sentiments are allowed from the user associated with user account C (215-3) before an action is executed. As a result, the victim may select several thresholds.

The user preferences may include specific terms associated with the negative sentiments. The victim may specify terms such as unacceptable behavior X, refuses, against, other terms or combinations thereof. If these specify terms are identified in messages, the messages may be identified as messages with negative sentiments.

Further, the user preferences may include a number of user generated messages to generate. The victim may specify that three user generated messages are to be generated. The victim may specify that four computer generated messages are to be generated. In some examples, the number of messages to generate may be a ratio or a percentage relative to the number of messages with negative sentiments. For example, two user generated messages are to be generated for every message with negative sentiments. Alternatively, the number of messages to generate may be a constant quantity such as ten.

The user preferences may further include an arrival rate of the computer generated messages and/or user generated messages. The arrival rate may specify when user generated messages and/or computer generated messages are to be posted on a wall of the victim. The arrival rate may be in terms of user generated messages and/or computer generated messages per minute. For example, the victim may specify at least three user generated messages and/or computer generated messages are to be posted to their wall every twenty minutes.

The user preferences may include an option to check facts. If a user posts a message with negative sentiments, the mediating system (210) may utilize a fact checking engine to determine if the message is true or not. More information about checking facts will be described in other parts of this specification.

The monitoring engine (214-2) monitors a number of messages (216-1, 216-2) in the social network (212). As mentioned above, the monitoring engine (214-2) may monitor the messages (216-1, 216-2) based on user preferences.

The analyzing engine (214-3) analyzes content of the number of messages (216-1, 216-2) to identify negative sentiments about a victim in the social network. As mentioned above, user preferences may determine if negative sentiments are found in the messages (216-1, 216-2). Various methods and techniques may be used to identify negative sentiments about a victim in the social network. For example, natural language processing (NLP) may be used. NLP enables the mediating system of FIG. 2 to derive meaning from the messages (216-1, 216-2). NLP may derive meaning from the messages (216-1, 216-2) by analyzing content of the messages (216-1, 216-2) and identifying if the sentiments (218-1, 218-2) are negative sentiments or positive sentiments.

The determining engine (214-4) determines a threshold, the threshold defining a maximum number of the messages containing the negative sentiments that are allowed to be disseminated about the victim. The determining engine (214-4) may determine the threshold by receiving the user preferences selected by the victim. If the user preferences indicate that three messages with negative sentiments are allowed to be disseminated about the victim, the threshold is three.

The executing engine (214-5) executes, based on the threshold, an action to mediate the negative sentiments about the victim. The action may include alerting the victim via an alert. The alert may be sent via electronic mail (email), instant message (IM), a short message service (SMS) message, or combinations thereof.

The action may further include generating computer generated messages. Generating the computer generated messages may include determining a number of the computer generated messages to generate. As mentioned above, the victim may specify the number of the computer generated messages to generate. Further, generating the computer generated messages may include generating the number of the computer generated messages with keywords, adjectives, phrases, positive sentiments, correct facts, or combinations thereof. The keywords, adjectives, phrases, positive sentiments, correct facts, or combinations thereof may be created using similar language as the messages with negative sentiments, but may include positive sentiments. Generating the computer generated messages may include creating a temporary email identification (ID) associated with each of the computer generated messages. The temporary email ID may be created to give the appearance that the computer generated messages are from valid users. The temporary email ID may be valid for a specific amount of time. The amount of time may be in years, weeks, days, hours, minutes, seconds, or combinations thereof. Further, the temporary email ID may be created by the victim when the victim creates the user account. The victim may specify scripts that the computer generated messages are to follow. Further, generating the computer generated messages may include posting the number of the computer generated messages to a wall of the victim. As illustrated message D (216-4) may be a computer generated message that is posted to the wall of user account A (215-1). Further, sentiment D (218-4) may include sentiments that refute message A (216-1).

The action may further include generating user generated messages. Generating the user generated messages may include determining a number of the user generated messages to generate. As mentioned above, the victim may specify the number of the user generated messages to generate. Further, generating the user generated messages may include prompting users of the social network to generate the user generated messages with positive sentiments, correct facts, or combinations thereof. For example, if the user preferences specify three user generated messages are to be generated, the executing engine (214-5) may prompt three users to generate a user generated message. Generating the user generated messages may include posting the number of the user generated messages to a wall of the victim. As illustrated message C (216-3) may be a user generated message, generated by a user associated with user account E (215-5), that is posted to the wall of user account A (215-1). Further, sentiment C (218-3) may include sentiments that refute message B (216-2).

An overall example will now be described with reference to FIG. 2. As described above, the victim is the user associated with user account A (215-1). The receiving engine (214-1) receives a number of user preferences for the victim. The receiving engine (214-1) may receive user preferences specifying that the victim selected a threshold of zero, user generated messages as one, computer generated messages as two, and topics such as traffic tickets.

The monitoring engine (214-2) monitors the number of messages (216) in a social network. User B (215-1) posts message A (216-1) on user account A's wall. Since message A (216-1) is posted on user account A's wall, the monitoring engine (214-2) monitors messages A (216-1). The monitoring engine may monitor other messages that are not posted on the wall of user account A (215-1).

The analyzing engine (214-3) analyzes content of messages A (216-1) to identify negative sentiments about the victim in the social network (212). Message A (216-1) may include a statement that the victim received a traffic ticket. As a result, sentiment A (218-1) of message A (216-1) may include negative sentiments about the victim.

The determining engine (214-4) determines a threshold, the threshold defining a maximum number of the messages containing the negative sentiments that are allowed to be disseminated about the victim. As mentioned above, the victim selects a threshold of zero. As a result, one message containing a negative sentiment exceeds the threshold.

The executing engine (214-5) executes, based on the threshold, an action to mediate the negative sentiments about the victim. Since, the threshold is exceeded, the executing engine (214-5) executes an action based on the user preferences. As a result, two computer generated messages, such as message B (216-2) and message C (216-3) are generated to refute that the victim received a traffic ticket. Further, a user associated with user account E (215-5) is prompted to generate a user generated message. The user associated with user account E (215-5) generates message D (216-4). Message D (216-4) may further refute that the victim received a traffic ticket. As a result, the computer generated messages and the user generated messages serve to dilute and counteract the negative sentiments in message A (216-1). While this example has been described with reference to the messages (216) being posted on the victim's wall, the messages (216) may be posted in any appropriate location. For example, if a message with negative sentiment about the user associated with user account A (215-1) is posted on user account B's wall, the messages (216) may be posted on user account B's wall. As a result, messages with positive sentiments may be posted and/or sent to the same or similar destinations as the messages with negative sentiments.

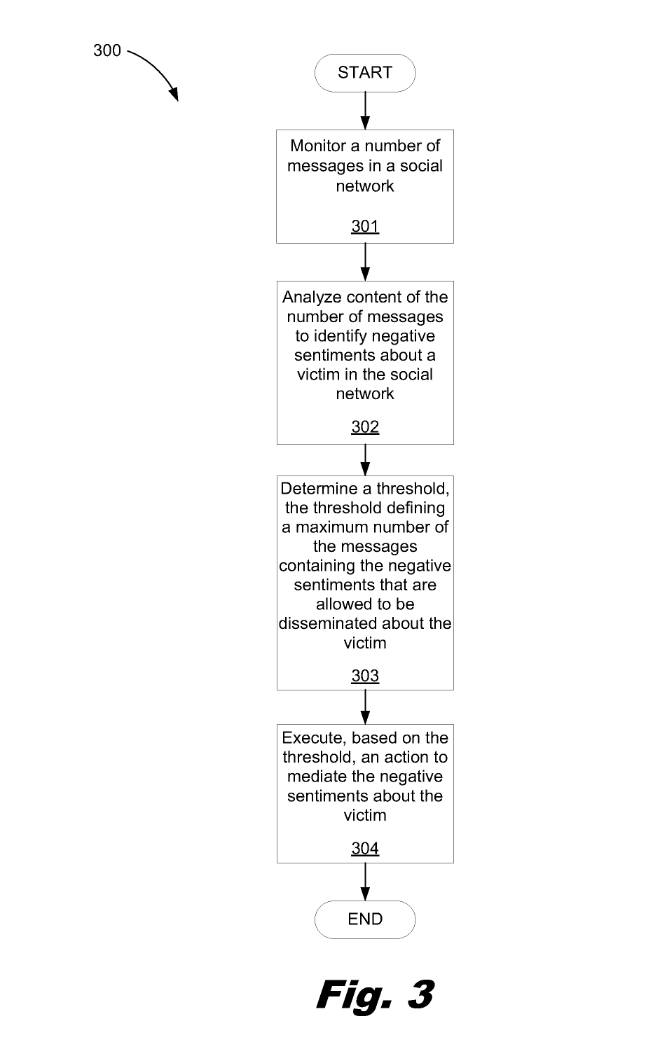

FIG. 3 is a flowchart of a method for mediating messages with negative sentiments in a social network, according to one example of principles described herein. The method (300) may be executed by the mediating system (100) of FIG. 1. The method (300) may be executed by other systems (i.e. system 200, system 500, and system 600). In this example, the method (300) includes monitoring (301) a number of messages in a social network, analyzing (302) content of the number of messages to identify negative sentiments about a victim in the social network, determining (303) a threshold, the threshold defining a maximum number of the messages containing the negative sentiments that are allowed to be disseminated about the victim, and executing (304), based on the threshold, an action to mediate the negative sentiments about the victim.

As mentioned above, the method (300) includes monitoring (301) a number of messages in a social network. The monitoring (301) may monitor more than messages in the social network. For example, the monitoring (301) may monitor any kind of document such as restaurant reviews, book reviews, information associated with historical figures, responses to written articles. Further, the monitoring (301) may monitor other communication systems such as websites, SMS, emails, other communication systems or combinations thereof. The monitoring (301) may be based on a specific interval of time. The interval of time may be years, weeks, days, hours, minutes, seconds, or combinations thereof.

As mentioned above, the method (300) includes analyzing (302) content of the number of messages to identify negative sentiments about a victim in the social network. The messages may be analyzed for words such as topics, terms, phrases, names, other words, or combinations thereof.

As mentioned above, the method (300) includes determining (303) a threshold, the threshold defining a maximum number of the messages containing the negative sentiments that are allowed to be disseminated about the victim. As mentioned above, the threshold may be selected by the victim via the user preferences.

As mentioned above, the method (300) includes executing (304), based on the threshold, an action to mediate the negative sentiments about the victim. The action may include alerting the victim via an alert, generating computer generated messages, generating user generated messages, or combinations thereof. The computer generated messages may use the message with the negative sentiments about the victim as a template. The computer generated messages may negate the message with the negative sentiments about the victim to create a message with positive sentiments. As a result, the computer generated messages may include similar phrasing or style, but with positive sentiments.

In other examples, the computer generated messages may be entirely different messages. The method (300) may store all messages with positive sentiments about the victim over a period of time. If a message with negative sentiments is identified, the method (300) may post one of the stored messages with positive sentiments to the wall of the victim.

Further, the action may include fact checking. Fact checking may include identifying an original author or original document. Further, fact checking may include determining the probability that the original author or original document is the true original author or original document. To determine the probability that the original author or original document is the true original author or original document, a derivation of the probable origination date is accomplished using a stream of data such as Big Data that is captured from the Internet and from other documentation sources. This may include historical information about the document, its author, related environmental data, social media data, blogs, tweets, posts, historical information, among others. Using textual analysis, statistical analytics, and artificial intelligence, all of this information is combined and correlated to extract clues that would indicate who the original author might be and when he/she may have created the article. Based on the number of conflicting or validating references, and the relationships between them, the method (300) generates a probability or confidence score in the accuracy of the analysis.

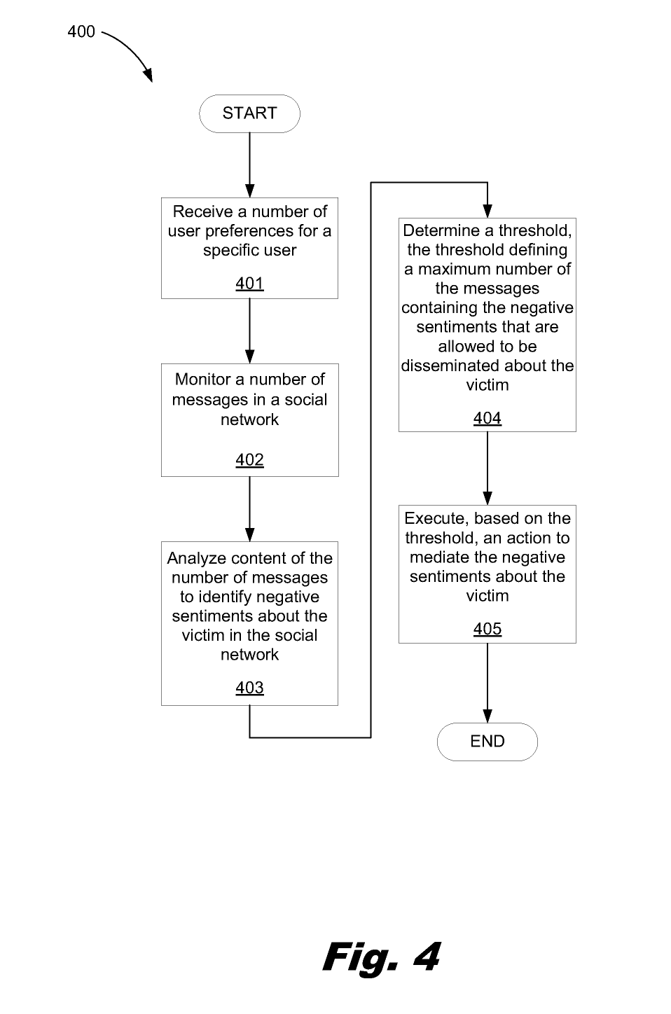

FIG. 4 is a flowchart of a method for mediating messages with negative sentiments in a social network, according to one example of principles described herein. The method (400) may be executed by the mediating system (100) of FIG. 1. The method (400) may be executed by other systems (i.e. system 200, system 500, and system 600). In this example, the method (400) includes receiving (401) a number of user preferences for the victim, monitoring (402) a number of messages in a social network, analyzing (403) content of the number of messages to identify negative sentiments about a victim in the social network, determining (404) a threshold, the threshold defining a maximum number of the messages containing the negative sentiments that are allowed to be disseminated about the victim, and executing (405), based on the threshold, an action to mediate the negative sentiments about the victim.

As mentioned above, the method (400) includes receiving (401) a number of user preferences for the victim. A UI may be presented to the victim via a display of a user device. The UI may include a number of user preferences. The user preferences may be selected by the victim. For example, if the UI includes a radio button next to a user preference, the victim may select the radio button to indicate this is a user preference. The user preferences may be defined and/or selected by the victim. For example, the UI may include a number of text boxes. The text boxes allow the victim to specify user preferences.

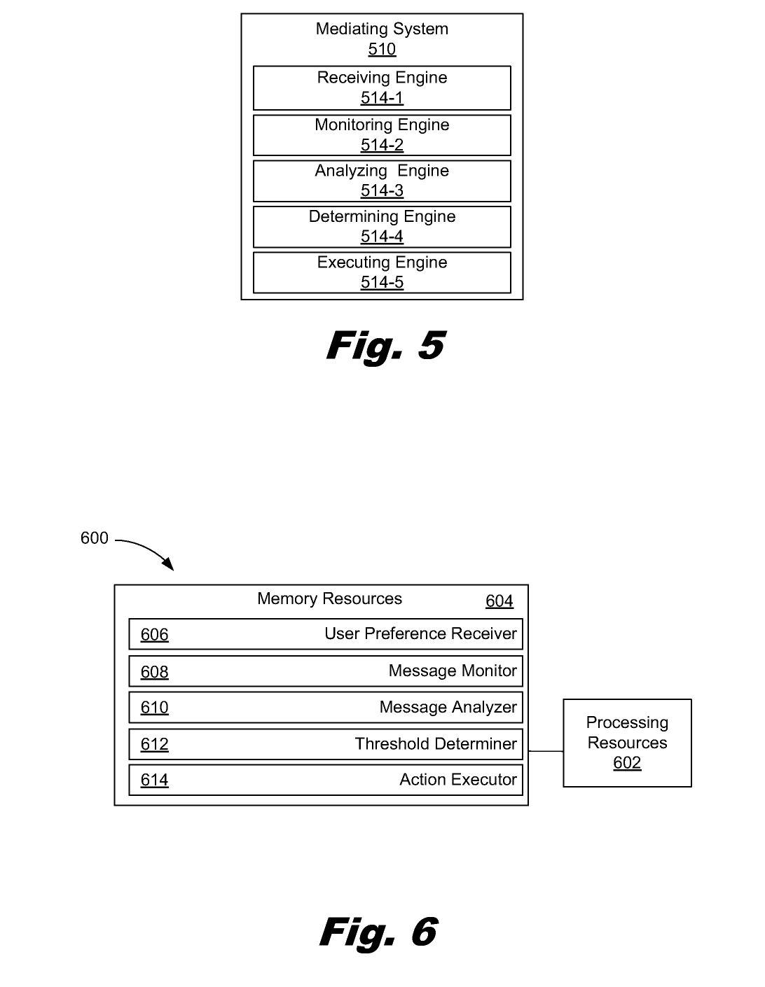

FIG. 5 is a diagram of a mediating system, according to the principles described herein. The mediating system (510) includes a number of engines (514). The engines (514) may include a receiving engine (514-1), a monitoring engine (514-2), an analyzing engine (514-3), a determining engine (514-4), and an executing engine (514-5). In an example, the engines (514) refer to a combination of hardware and program instructions to perform a designated function. Alternatively, the engines (514) may be implemented in the form of electronic circuitry (e.g., hardware). Each of the engines (514) may include a processor and memory. Alternatively, one processor may execute the designated function of each of the engines (514). The program instructions are stored in the memory and cause the processor to execute the designated function of the engine. In other examples, the mediating system (510) includes a processor and computer program code. The computer program code is communicatively computed to the processor. The computer program code includes the number of engines (514). The engines (514) refer to program instructions to perform a designated function. The program code causes the processor to execute the designated function of the engines (514).

The receiving engine (514-1) receives a number of user preferences for the victim. The receiving engine (514-1) may receive one user preference for the victim. The receiving engine (514-1) may receive several user preferences for the victim.

The monitoring engine (514-2) monitors a number of messages in a social network. The monitoring engine (514-2) monitors all messages associated with the victim in a social network. The monitoring engine (514-2) monitors all messages posted to a wall of the victim.

The analyzing engine (514-3) analyzes content of the number of messages to identify negative sentiments about a victim in the social network. The analyzing engine (514-3) analyzes content of messages from a group of users to identify negative sentiments about a victim in the social network.

The determining engine (514-4) determines a threshold, the threshold defining a maximum number of the messages containing the negative sentiments that are allowed to be disseminated about the victim. The determining engine (514-4) determines the threshold based on user preferences selected by the victim.

The executing engine (514-5) executes, based on the threshold, an action to mediate the negative sentiments about the victim. The executing engine (514-5) may execute one action. The executing engine (514-5) may execute several actions.

FIG. 6 is a diagram of a mediating system, according to the principles described herein. In this example, the mediating system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the mediating system (600). The programmed instructions shown stored in the memory resources (604) include a user preference receiver (606), a message monitor (608), a message analyzer (610), a threshold determiner (612), and an action executor (614).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The user preference receiver (606) represents programmed instructions that, when executed, cause the processing resources (602) to receive a number of user preferences for a victim. The message monitor (608) represents programmed instructions that, when executed, cause the processing resources (602) to monitor a number of messages in a social network.

The message analyzer (610) represents programmed instructions that, when executed, cause the processing resources (602) to analyze content of the number of messages to identify negative sentiments about the victim in the social network. The threshold determiner (612) represents programmed instructions that, when executed, cause the processing resources (602) to determine a threshold, the threshold defining a maximum number of the messages containing the negative sentiments that are allowed to be disseminated about the victim. The action executor (614) represents programmed instructions that, when executed, cause the processing resources (602) to execute, based on the threshold, an action to mediate the negative sentiments about the victim.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the mediating system (600) may be implemented on a user device, on a server, on a collection of servers, or combinations thereof.

The mediating system (600) of FIG. 6 may be part of a general purpose computer. However, in alternative examples, the mediating system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

The flowchart and block diagrams in the figures illustrate the architecture, functionality, and operations of possible implementations of systems, methods, and computer program products. In this regard, each block in the flowchart or block diagrams may represent a module, segment, or portion of code, which has a number of executable instructions for implementing the specific logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration and combination of blocks in the block diagrams and/or flowchart illustration, can be implemented by special purpose hardware-based systems that perform the specified functions or acts, or combinations of special purpose hardware and computer instructions.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

What is claimed is:

1. A method for mediating messages with negative sentiments in a social network, the method comprising:
monitoring a number of messages in a social network;
analyzing content of the number of messages to identify negative sentiments about a victim in the social network;
determining a threshold, the threshold defining a maximum number of the messages containing the negative sentiments that are allowed to be disseminated about the victim; and
executing, based on the threshold, an action to mediate the negative sentiments about the victim.

2. The method of claim 1, in which the action comprises alerting the victim via an alert, generating computer generated messages, generating user generated messages, or combinations thereof.

3. The method of claim 2, in which generating the computer generated messages comprises:
determining a number of the computer generated messages to generate;
generating the number of the computer generated messages with keywords, adjectives, phrases, positive sentiments, correct facts, or combinations thereof;
creating a temporary email identification (ID) associated with each of the computer generated messages; and
posting the number of the computer generated messages to a wall of the victim.

4. The method of claim 2, in which generating the user generated messages comprises:
determining a number of the user generated messages to generate;
prompting users of the social network to generate the user generated messages with positive sentiments, correct facts, or combinations thereof; and
posting the number of the user generated messages to a wall of the victim.

5. The method of claim 2, in which the alert is sent via electronic mail (email), instant message (IM), a short message service (SMS), or combinations thereof.

6. The method of claim 1, further comprising receiving a number of user preferences for the victim.

7. The method of claim 6, in which the user preferences comprises a time for monitoring the number of messages in the social network, topics associated with the negative sentiments, the threshold, specific terms associated with the negative sentiments, an arrival rate of the positive messages, a number of user generated messages to generate, a number of computer generated messages to generate, facts to check, or combinations thereof.

8. A system for mediating messages with negative sentiments in a social network, the system comprising:
a receiving engine to receive a number of user preferences for a victim;
a monitoring engine to monitor a number of messages in a social network;
an analyzing engine to analyze content of the number of messages to identify negative sentiments about the victim in the social network;
a determining engine to determine a threshold, the threshold defining a maximum number of the messages containing the negative sentiments that are allowed to be disseminated about the victim; and
an executing engine to execute, based on the threshold, an action to mediate the negative sentiments about the victim.

9. The system of claim 8, in which the action comprises alerting the victim via an alert, generating computer generated messages, generating user generated messages, or combinations thereof.

10. The system of claim 9, in which generating the computer generated messages comprises:
determining a number of the computer generated messages to generate;
generating the number of the computer generated messages with keywords, adjectives, phrases, positive sentiments, correct facts, or combinations thereof;
creating a temporary email identification (ID) associated with each of the computer generated messages; and
posting the number of the computer generated messages to a wall of the victim.

11. The system of claim 9, in which generating the user generated messages comprises:
determining a number of the user generated messages to generate;
prompting users of the social network to generate the user generated messages with positive sentiments, correct facts, or combinations thereof; and
posting the number of the user generated messages to a wall of the victim.

12. The system of claim 9, in which the alert is sent via electronic mail (email), instant message (IM), a short message service (SMS), or combinations thereof.

13. The system of claim 8, in which the user preferences comprises a time for monitoring the number of messages in the social network, topics associated with the negative sentiments, the threshold, specific terms associated with the negative sentiments, an arrival rate of the positive messages, a number of user generated messages to generate, a number of computer generated messages to generate, facts to check, or combinations thereof.

14. A computer program product for mediating messages with negative sentiments in a social network, comprising:
a tangible computer readable storage medium, the tangible computer readable storage medium comprising computer readable program code embodied therewith, the computer readable program code comprising program instructions that, when executed, causes a processor to:
analyze content of a number of messages to identify negative sentiments about a victim in a social network;
determine a threshold, the threshold defining a maximum number of the messages containing the negative sentiments that are allowed to be disseminated about the victim; and
execute, based on the threshold, an action to mediate the negative sentiments about the victim.

15. The product of claim 14, further comprising computer readable program code comprising program instructions that, when executed, cause the processor to receive a number of user preferences for the victim.

16. The product of claim 14, further comprising computer readable program code comprising program instructions that, when executed, cause the processor to monitor the number of messages in the social network.

17. The product of claim 14, in which the action comprises alerting the victim via an alert, generating computer generated messages, generating user generated messages, or combinations thereof.

18. The product of claim 17, in which the computer generated messages are generated by:
determining a number of the computer generated messages to generate;
generating the number of the computer generated messages with keywords, adjectives, phrases, positive sentiments, correct facts, or combinations thereof;
creating a temporary email identification (ID) associated with each of the computer generated messages; and
posting the number of the computer generated messages to a wall of the victim.

19. The product of claim 17, in which the user generated messages are generated by:
determining a number of the user generated messages to generate;
prompting users of the social network to generate the user generated messages with positive sentiments, correct facts, or combinations thereof; and
posting the number of the user generated messages to a wall of the victim.

20. The product of claim 15, in which the user preferences comprises a time for monitoring the number of messages in the social network, topics associated with the negative sentiments, the threshold, specific terms associated with the negative sentiments, an arrival rate of the positive messages, a number of user generated messages to generate, a number of computer generated messages to generate, facts to check, or combinations thereof.
